(19) United States
(12) Patent Application Publication
(10) Pub. No.: US 2024/0358128 A1
(43) Pub. Date: Oct. 31, 2024

(54) Modular walking cane providing wrist support and stability

(71) Applicant: Telo LLC, North Oaks, MN (US)

(72) Inventors: Steven Bleau, Bloomington, MN (US); Morgan Kerfeld, North Oaks, MN (US); Elizabeth Urbanski, Brookfield, WI (US)

(21) Appl. No.: 18/648,071

(22) Filed: Apr. 26, 2024

Related U.S. Application Data
(60) Provisional application No. 63/462,391, filed on Apr. 27, 2023.

(51) Int. Cl. A45B 9/02; A45B 7/00

(52) U.S. Cl. CPC A45B 9/02; A45B 7/005; A45B 2200/05

(57) ABSTRACT

A walking cane having an overall Y-shape with each of a handle and wrist support extending away from connection with a vertical ground engaging shaft of the cane at an angle. The walking cane provides enhanced comfort, support, stability, and versatility to users. A Y-shaped upper portion with an ergonomic handle portion encourages proper height setting, provides wrist support, promotes a natural grip, and reduces hand and wrist strain. Magnetic clips located on each cane allow it to be securely snapped to another cane for easy storage and transport. Using two canes in tandem further provides bilateral support. The cane's upper portion angle is based on the angle of an individual in a neutral standing position so that, during use, the cane mirrors the user's leg angle to promote a more proper and natural gait. An integrated height adjustment mechanism allows for user customization. The cane also features lightweight and durable construction, with a non-slip rubber tip for added stability and safety. The cane may be modular in nature to allow for individual customization with an upper portion removably secured to the lower portion support leg.

### CROSS-REFERENCE TO RELATED APPLICATION

The present application claims priority to and the benefit of U.S. provisional patent application Ser. No. 63/462,391, filed on Apr. 27, 2023, the content of which is hereby incorporated in its entirety.

### FIELD OF THE INVENTION

The present invention relates to the field of mobility aids, namely devices designed with the purpose of assisting ambulatory and non-ambulatory persons with their walking or movement. More specifically, the present invention relates to a walking cane having an upper portion with a handle and a wrist support both located at a junction with a vertical support leg.

### BACKGROUND

Common mobility aids include walkers, rollator walkers, wheelchairs, power chairs, and canes. As it stands, a cane is a mobility device used by individuals to provide extra stability while walking. This device is used by a variety of individuals including those with ambulatory problems due to old age or underlying health conditions. A cane generally consists of a shaft, handle, ferrule (the rubber tip or cap placed at the bottom of the cane) and collar (metal or plastic band that secures the ferrule to the shaft).

The current standard for a cane is a straight shaft made of some form of metal. Attached to the shaft is a handle that users apply weight to while walking for added support. While providing some stability, this design leaves users' wrists capable of 360-degree rotation providing limited support and making it difficult for some to utilize.

To gain additional support and stability some cane users will opt to use trekking poles or forearm crutches instead. These devices, however, alter the user's gait pattern in harmful ways. Trekking poles require the individual to push back on the device and forearm crutches to lean onto the device. These limitations leave an opportunity for a walking cane that provides additional support and stability but does not alter an individual's natural walking pattern.

Furthermore, canes are typically used on a single side of the body and are not optimized for dual usage. This often leads to an asymmetrical walking pattern and poor gait habits as users rely on one side more than the other.

As it stands there exists a gap in the spectrum of mobility aids between a single-point cane and rollator walker that provides an individual additional stability and support while encouraging natural walking patterns. With no modular options available on the market there also exists a gap in a cane that allows for swappable upper portions, improving the ability to progress with the same device as mobility function changes and progresses.

Since its invention, new categories of canes have emerged, each offering small glimpses of innovation. These include the following: Traditional wooden walking canes—These canes have a simple design and are usually made from a single piece of wood. They feature a curved handle at the top for gripping and a pointed tip for stability. Adjustable aluminum canes—These canes are more modern and offer adjustable height settings to accommodate different users. They are typically made from lightweight aluminum and feature rubber tips for stability. Quad canes—Quad canes have a wider base than traditional canes, providing more stability. They are often used by individuals with balance or stability issues. Folding canes—Folding canes are designed to be more portable and convenient for users. They can be easily folded up and stored in a bag or purse when not in use. Specialty canes—There are also some types of specialty canes available, such as those designed for individuals with visual impairments or those with ergonomic grips to reduce hand fatigue.

While current canes aid ambulation, they can often lead to mobility issues themselves by encouraging poor posture, only being designed for unilateral support, and being unstable with wrists having full range of motion. Additionally, canes are often used improperly which can worsen posture over time. One contributing factor is the freedom of motion at the wrist, which allows users to continue using the cane even if it's set too high or too low. This flexibility can lead to a false sense of security or comfort, causing the user to overlook the need for proper cane height adjustment. When a cane is set at an incorrect height, it can contribute to poor posture by forcing the user to hunch over or by causing awkward arm positioning. This, in turn, can lead to an imbalanced gait, muscle strain, and increased pain or discomfort.

As time goes on users become more reliant on assistive devices as their mobility continues to decline while utilizing their canes. Eventually, users adopt more assistive devices such as a rollator walker until, eventually, they lose their mobility entirely.

In general, therefore, there is a need for a cane that fills the current gap in the range of assistive devices by improving the wrist stability of its user, providing bilateral support, and encouraging a natural gait. Furthermore, the need for a modular cane that can adapt as a user's mobility function changes or as a user progresses in mobility decline is noticed. The present invention sets out to address the issues associated with conventional canes, correct and improve upon the deficiencies in the prior art, and provide a means to circumvent the associated drawbacks of such prior art designs.

### SUMMARY

An aspect of the present disclosure relates to a walking cane comprising an upper portion comprising a handle and a wrist support; and a lower portion comprising a support leg, wherein the handle and wrist support are spaced apart from one another and extend from the support leg at diverging angles.

The upper portion has an overall branched shape or a “Y” shape.

The upper portion is removably coupled to the lower portion allowing the upper portion to be interchangeable with a second upper portion of different support levels, colors, material of construction or combinations thereof and swapped out for an upper portion of different support, color, material of construction or combinations thereof.

The upper portion is comprised of a lightweight and durable material.

One or more cane attachment mechanisms are configured to allow for the coupling of two walking canes together for transport or storage, wherein the one or more attachment mechanisms comprise a magnetic clip. The attachment mechanism comprises two magnetic clips with one magnetic clip positioned on the upper portion of the cane's support leg and a second magnetic clip positioned on the lower portion of the cane's support leg.

A replaceable hand grip can be detached from the handle and interchanged with a second hand grip of different material, construction, color, or combination thereof.

A height adjustment mechanism allows for selection of one of various heights of the lower portion.

The height adjustment mechanism comprises a locking mechanism for securely retaining the cane at the selected height.

The cane further comprises a non-slip rubber tip at a terminal end of the lower portion. The non-slip rubber tip is removable and replaceable.

The cane is modular, comprising one or more interconnectable components that can be removed and interchanged with a same or similar component constructed from a different material, having a different color, providing a different support, a different size, or combinations thereof such that the walking cane is customizable.

Another aspect of the present disclosure relates to a walking cane comprising a ground engaging length supporting a handle on an upper end of the length, wherein the handle extends outwardly from connection with the ground engaging length at an angle such that the handle extends along an axis that is neither parallel nor perpendicular to an axis of the ground engaging length.

A wrist support length extends outwardly from connection with the ground engaging length at an angle such that the wrist support extends along an axis that is neither parallel nor perpendicular to an axis of the ground engaging length.

The ground engaging length, wrist support, and handle provide an overall “Y” shape to the walking cane.

The upper portion has an ergonomic design configured to promote a natural grip and reduce hand and wrist strain.

The Y-shaped upper portion provides wrist support to promote proper posture, improve stability, and reduce wrist strain during use.

Another aspect of the present disclosure relates to a modular walking cane comprising a vertical support having an adjustable overall length and an upper portion that is removably securable to the vertical support such that the walking cane is a multi-purpose walking cane capable of adapting to a user's changing mobility function.

The upper portion comprises one of an upper portion having a handle, an upper portion having a handle and a wrist support, or an upper portion having a handle and a forearm support.

### BRIEF DESCRIPTION OF THE DRAWINGS

FIG. 1 is a perspective view of a walking cane according to one or more embodiments described herein.

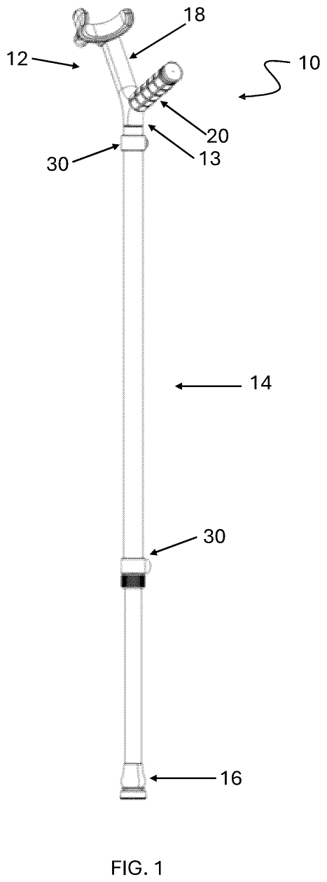

FIGS. 2A-2B illustrate a modular nature of the walking cane showing removable attachment of an upper portion of the walking cane to a lower portion of the walking cane.

FIGS. 3A-3B illustrate the modular nature of the walking cane showing removable attachment of another embodiment of an upper portion of the walking cane to a lower portion of the walking cane.

FIG. 4 illustrates an interchangeable base or foot of the walking cane.

FIGS. 5A-5B illustrate a height adjustment mechanism for the walking canc.

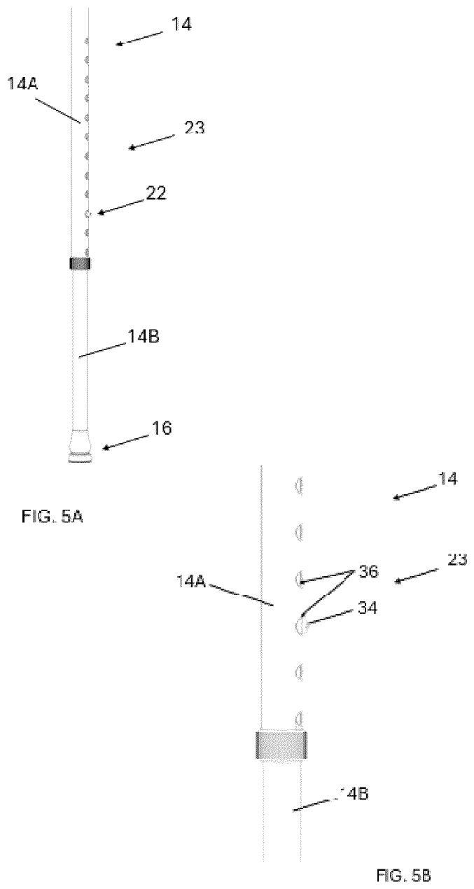

FIG. 6 illustrates an attachment mechanism for securing two walking canes together for storage or transport and in a removable manner.

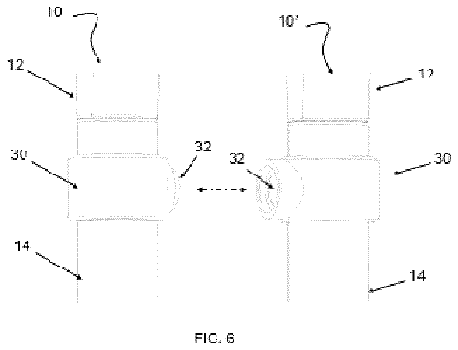

FIGS. 7A-7B illustrate a pair of walking canes for use in some embodiments where two walking canes are desired for bilateral support.

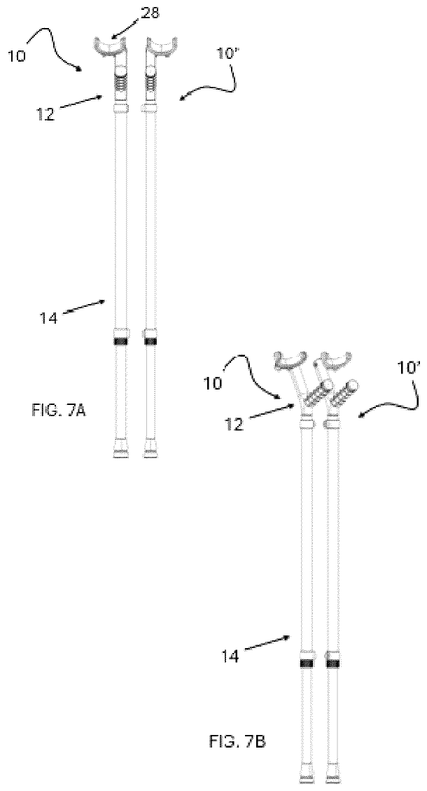

### DETAILED DESCRIPTION

Described herein is a walking cane designed to enhance posture, weight support, and stability for a user. The walking cane comprises an upper portion with a handle and a wrist support. In one or more embodiments, the upper portion has the handle and the wrist support in a “Y” orientation such that the upper portion is “Y-shaped”. The Y-shaped upper portion provides wrist support to limit the 360-degree freedom of movement with respect to a user's wrist present in prior art canes. The walking cane according to one or more embodiments described herein provides additional support and stability, while reducing hand and wrist strain. It also encourages users to adjust the cane to its proper height for any given user. An angle of the upper portion is based on an angle of an individual user in a neutral standing pose. This allows, during use, the cane to mirror the angle of the user's leg promoting a more proper and natural gait.

The upper portion of the walking cane comprises the handle and the wrist support, where the handle and wrist support are spaced apart from one another and extend from a vertical support leg of the cane, at opposing angles that may also be non-vertical angles. That is, overall, the upper portion of the cane, which engages a user's hand and wrist, or lower forearm, may have a “Y” shape or substantially branched shape formed by the extension of the handle and wrist support from the vertical support. The vertical support leg or shaft then extends therefrom to engage the ground or walking surface on which the user traverses.

The wrist support portion of the walking cane may be integrally formed or otherwise fixedly secured with the shaft of the cane and an elbow provided at the location of connection between the wrist support portion and the shaft, providing a connection point that forms a first angle. The handle then may extend outwardly from connection with the wrist support portion or the shaft, and/or the connection point therebetween, in a manner that provides a second angle formed between the wrist support portion and the handle, which is in the range of approximately 90 to approximately 110 degrees and for example may be approximately 102 degrees.

In some embodiments, the upper portion may be interchangeable, making the cane modular in nature. Users can then easily swap out the upper portion for different colors, supports, or materials to further customize the cane for user specific needs or preferences. For example, the upper portion may be swapped out for a traditional single-point cane handle or an upper portion with handle and forearm support depending on the level of support or stability any given user requires.

In one embodiment of the device, the hand grip(s) may also be made interchangeable to make it easy for users to customize the cane to their preferences with different colors, materials, or form factors.

The walking cane is also designed to give users the option and ability to use it in tandem with a second cane of the same or substantially similar design and/or construction, providing bilateral support to the user if desired. In such embodiments, the two canes may be securely snapped together for easy storage and transport by way of magnetic clips or other removeable coupling devices or fasteners, adding convenience to the user's daily routine. Each walking cane may be provided with one or more magnetic connection points, for example, two magnetic connection points may be provided with one positioned near the top of the walking cane and one positioned near the bottom of the walking cane. Alternative and/or additional placement of the connection points is contemplated and within the scope of this disclosure. The configuration of the upper portion of the cane allows two canes to be aligned side by side in a compact manner for case of transport and/or storage.

The walking cane is of lightweight and durable construction, making it easy to use for extended periods of time. A non-slip tip, such as a textured and/or rubber tip (ferrule) may also be included to provide added stability and safety. In some embodiments this ferrule may be interchangeable, also making the cane modular in nature. Users could then easily swap out the ferrule for different colors, supports, or materials to further customize their cane for their needs or preferences or to account for use on different terrain or weather conditions. For example, the ferrule could be swapped out for a three or four-prong tip to create a wider base.

Additionally, a built-in height adjustment mechanism may allow users to customize the cane to their specific needs, ensuring maximum comfort and support. The built-in height adjustment mechanism may be provided along a length of the shaft, near the ferrule, near the connection of the shaft to the upper portion, or combinations thereof. The height adjustment mechanism may comprise telescoping length sections securable at a selected length with a manual push activated button or clip which is received by a selected aperture corresponding to a selected length.

In the embodiment illustrated in the figures, a walking cane 10 comprises an upper portion 12 and a lower portion 14. The upper portion 12 comprises a handle 20 and a wrist support 18. The handle 20 and the wrist support 18 extend from a base 13 of the upper portion 12 each at an angle such that the handle 20 and the wrist support 18 diverge from one another as they extend from the base 13. The handle 20 may be provided with a texture for grip and/or an optional hand grip that may be removably placed over the handle 20. The wrist support 18 may further comprise one or more ergonomic support surfaces 28 for a user to rest thereon such that a location on a user between the wrist and forearm rests on the support surface 28. The ergonomic support surface 28 is adjustable and interchangeable as secured to the wrist support 18. An angle 19 formed between the plane of the handle 20 and a plane of the wrist support 18 may vary but is approximately 102° in the embodiment illustrated.

The lower portion 14 of the walking cane 10 comprise a vertical support leg extending to a ground engaging tip 16. A length of the vertical support leg is also adjustable to adjust the overall height of the walking cane 10 and location of the upper portion 12 with respect to a user's height and arm/hand location when walking. An adjustment mechanism 23 for extending or shortening the length of the support leg comprises a multi-component and/or telescoping lower portion 14. The lower portion 14 may be comprised of two components 14A and 14B, wherein component 14B is a tubular extension that is slidable within a hollow or open length of component 14A. A securing or locking mechanism 22 is provided to secure a location of component 14B within component 14A and thus to secure an overall length of the lower portion 14. The locking mechanism 22 illustrated comprises a pin 34 that is spring based and secured at a selected location on component 14B and can be depressed until engagement with a selected aperture 36 spaced apart along a length of component 14A. The pin 34 engages with a selected aperture 36 to secure a selected height or the length of the vertical support leg 14.

The walking cane 10 illustrated in the figures comprises two coupling mechanisms 30 which are positioned at two spaced apart locations on the cane 10. The coupling mechanisms 30 comprise a connection element 32 such that when two canes 10 and 10′ are stacked together, the respective coupling mechanisms 30 connect and hold the two canes 10 and 10′ together for ease of transport or storage. The connection element 32 may be a magnet or other friction fit element allowing two coupling mechanisms 30 to connect in a removable but secure manner.

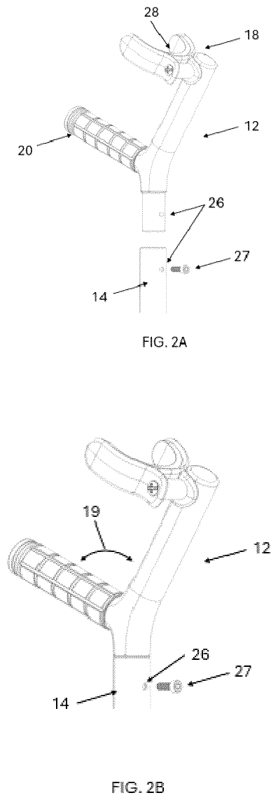

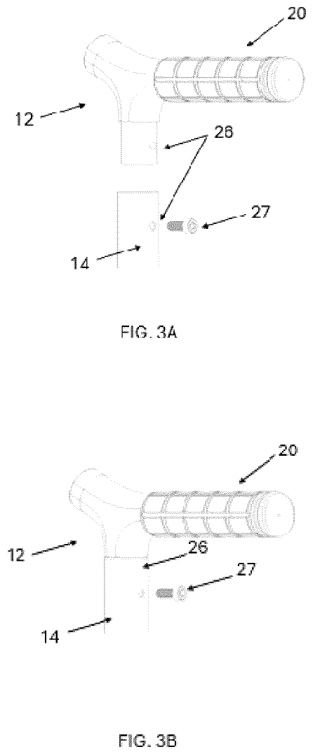

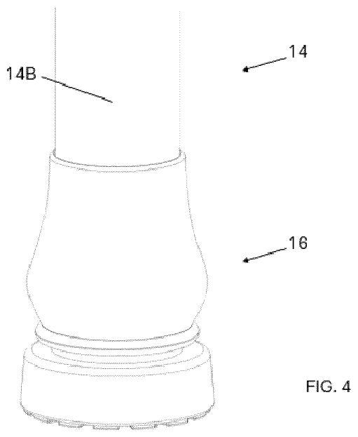

The upper portion 12 and lower portion 14 may be integrally formed or otherwise fixedly secured. In the embodiment illustrated, the walking cane 10 is modular and thus the upper portion 12 and the lower portion 14 are removably secured together via an interlocking connection mechanism 26 with securing element 27 as shown in further detail in FIGS. 2A-2B. Additionally, as shown in FIGS. 3A-3B, the upper portion 12 may have various configurations including a configuration without a wrist support secured thereto. That is, the level of support and directionality of support is selectable and changeable in the walking cane 10. Upper portions 12 can be exchanged by the user, a height of the lower portion 14 is also selectable adjustable by the user, as well as the size, texture and other features of the tip 16 can be selected by way of exchangeable tips 16. Further supporting an embodiment of the walking cane 10 that is modular in nature, the tip 16 may also be interchanged with one or more tips 16 to provide larger or smaller tips 16 or tips having additional texture or grip as shown in FIG. 4.

In one or more embodiments, one or more components of the walking cane may be formed by injection molding, resin casting, 3D printing, or other manufacturing methods. For example, the upper portion may be formed by an injection molding or resin casting process and constructed from one or more materials suitable for such methods of production. Hard plastics, lightweight metals such as aluminum or titanium may be used to construct one or more components of the walking cane. Additional components such as hand grips and surface grips may be further comprised of rubber, silicon, resilient foams, and the like.

In one or more embodiments, one or more components of the cane may be formed by an extrusion or hydroforming process. For example, the shaft of the walking cane may be constructed of aluminum or a similar material and formed by an extrusion process.

Alternative methods of production of one or more components of the cane are contemplated and within the scope of this disclosure such as 3D printing.

Although the present disclosure has been described with reference to preferred embodiments, workers skilled in the art will recognize that changes may be made in form and detail without departing from the spirit and scope of the disclosure.

1. A walking cane comprising:
an upper portion comprising a handle and a wrist support; and
a lower portion comprising a support leg,
wherein the handle and wrist support are spaced apart from one another and extend from the support leg at diverging angles.

2. The walking cane of claim 1 wherein the upper portion has an overall branched shape or a “Y” shape.

3. The walking cane of claim 1, wherein the upper portion is removably coupled to the lower portion allowing the upper portion to be interchangeable with a second upper portion of different support levels, colors, material of construction or combinations thereof and swapped out for an upper portion of different support, color, material of construction or combinations thereof.

4. The walking cane of claim 1, wherein the upper portion is comprised of a lightweight and durable material.

5. The walking cane of claim 1, and further comprising one or more cane attachment mechanisms configured to couple two walking canes together for transport or storage, wherein the one or more attachment mechanisms comprise a magnetic clip.

6. The walking cane of claim 5, wherein the attachment mechanism comprises two magnetic clips with one magnetic clip positioned on the upper portion of the support leg and a second magnetic clip positioned on the lower portion of the support leg.

7. The walking cane of claim 1, and further comprising a replaceable hand grip that can be detached from the handle and interchanged with a second hand grip of different material, construction, form factor, color, or combination thereof.

8. The walking cane of claim 1, and further comprising a height adjustment mechanism that allows for selection of one of various heights of the lower portion.

9. The walking cane of claim 8, wherein the height adjustment mechanism comprises a locking mechanism for securely retaining the cane at the selected height.

10. The walking cane of claim 1, wherein the cane further comprises a non-slip rubber tip at a terminal end of the lower portion.

11. The walking cane of claim 10, wherein the non-slip rubber tip is removable and replaceable with a different tip of varying construction, size of base, color, material, or combinations thereof.

12. The walking cane of claim 1, wherein the cane is modular, comprising one or more interconnectable components that can be removed and interchanged with a same or a different component constructed from a same or different material, having a same or different color, a same or different size, a same or different support, or combinations thereof such that the walking cane is customizable.

13. A walking cane comprising a ground engaging length supporting a handle on an upper end of the length, wherein the handle extends outwardly from connection with the ground engaging length at an angle such that the handle extends along an axis that is neither parallel nor perpendicular to an axis of the ground engaging length.

14. The walking cane of claim 13 and further comprising a wrist support length extending outwardly from connection with the ground engaging length at an angle such that the wrist support extends along an axis that is neither parallel nor perpendicular to an axis of the ground engaging length.

15. The walking cane of claim 13 wherein the ground engaging length, wrist support, and handle provide an overall “Y” shape to the walking cane.

16. The walking cane of claim 13, wherein the upper portion has an ergonomic design configured to promote a natural grip and reduce hand and wrist strain.

17. The walking cane of claim 13, wherein the Y-shaped upper portion provides wrist support to promote proper posture, improve stability, and reduce wrist strain during use.

18. A modular walking cane comprising a vertical support having an adjustable overall length and an upper portion that is removably securable to the vertical support such that the walking cane is a multi-purpose walking cane capable of adapting to a user's changing needs and mobility function.

19. The kit of claim 18 wherein the upper portion comprises one of an upper portion having a handle, an upper portion having a handle and a wrist support, or an upper portion having a handle and a forearm support.
